(19) United States
(12) Patent Application Publication
(10) Pub. No.: US 2021/0087109 A1
(43) Pub. Date: Mar. 25, 2021

(54) GEOPOLYMER COMPOSITIONS, CEMENTITIOUS COMPOSITION COMPRISING THE SAME, AND METHODS FOR MAKING THE SAME

(71) Applicants: MICHAEL R. BOYCE, Ponte Vedra Beach, FL (US); Joe Dotson, Pottstown, PA (US); Kevin Worley, Freeport, FL (US)

(72) Inventors: MICHAEL R. BOYCE, Ponte Vedra Beach, FL (US); Joe Dotson, Pottstown, PA (US); Kevin Worley, Freeport, FL (US)

(21) Appl. No.: 17/005,743

(22) Filed: Aug. 28, 2020

Related U.S. Application Data
(60) Provisional application No. 62/893,759, filed on Aug. 29, 2019.

(51) Int. Cl. C04B 12/00; C04B 28/00

(52) U.S. Cl. CPC C04B 12/005; C04B 2201/50; C04B 28/008

(57) ABSTRACT

A geopolymer material made from principal minerals, which comprises SiO₂, Al₂O₃, Fe₂O₃, TiO₂, and optionally trace amounts of calcium. Also disclosed are cementitious material comprised of the geopolymer and concrete made from mixing the geopolymer cementitious material with an alkaline solution. Methods of making the geopolymer composite as well as methods of making the geopolymer concrete are also disclosed.

This application claims the benefit of priority to U.S. Provisional Application No. 62/893,759, filed Aug. 29, 2019, which is incorporated herein by reference in its entirety.

### TECHNICAL FIELD

The present disclosure relates generally to geopolymer materials, methods of making them, and their use, for example, in cement production. The present disclosure also relates to compositions comprising the geopolymer materials. The present disclosure also relates to methods of making and using the disclosed compositions.

### BACKGROUND

Current practices for producing concrete involve the use of cement, most commonly Portland cement. Portland cement is produced by heating a mixture of limestone (i.e., CaCo₃, a carbonate) and aluminosilicate materials, such as clay minerals, at high temperature to form clinker. Clinker is produced through sintering of the limestone and aluminosilicate materials, a process that occurs at temperatures of about 1,450° C. Clinker is then ground, and small amounts of gypsum are typically added to the ground powder. Once ground up and mixed, the finished product is Portland cement. Portland cement can be used to produce concrete by mixing the cement with water to form a cement paste and mixing in fine and coarse aggregates.

Although Portland cement is cheap and readily available, it has been associated with a number of health issues. For example, Portland cement is caustic and can therefore cause chemical burns. In addition, Portland cement can cause irritation, and in some instances, lung cancer. It has also been known to contain hazardous materials such as crystalline silica and hexavalent chromium. Portland cement has also been associated with many environmental concerns. For example, there is a very high energy requirement to mine, manufacture, and transport the cement. The entire process results in an estimated 10% of global carbon dioxide emissions. Other air emissions associated with the process include dioxin, NOₓ, SO₂, and particulates. With the demand for cement production set to increase from between 12-23% by 2050, there is a need for more environmentally friendly cementitious compositions.

Thus, there is a continuing need for improved cementitious compositions that have enhanced economics of production, performance, and compressive strength properties to allow for a reduction in energy input and air pollution emissions.

The geopolymer materials described herein overcome one or more of the problems set forth above and/or other problems of the prior art. The disclosed geopolymer materials, and compositions comprising the same can be produced in a more energy and cost-efficient manner. Compositions according to this application also exhibit improved performance and compressive strength properties to allow for a reduction in energy input and air pollution emissions.

### SUMMARY

To address the foregoing needs, there is disclosed a geopolymer material made from principal minerals that comprises silicon dioxide, aluminum oxide, ferric oxide, and titanium dioxide, without the need for calcination. The principal minerals are derived from naturally occurring sources or from byproducts of mining operations.

In an embodiment, the principal minerals are derived from naturally occurring sources such as quartz, feldspar, staurolite, and clay. In a specific embodiment, the principal minerals are derived from a mixture of quartz and felspar. In this embodiment, the feldspar is potassium containing feldspar. The most common principal minerals found in the combination of clay, quartz, and feldspar used to produce geopolymers according to this disclosure are quartz and microcline. In another specific embodiment, the principal minerals are derived from quartz and staurolite. In another specific embodiment, the principal minerals are derived from quartz, staurolite, and feldspar.

In an embodiment, there is disclosed a method of making the geopolymer materials comprising combining the principal minerals with a first sodium silicate to create a sodium silicate combination, create the final geopolymer cementitious material. In an embodiment, the disclosed method of making the geopolymer does not require a calcining step.

In an embodiment, there is disclosed a concrete made from the geopolymer cementitious material derived from principal minerals that comprises silicon dioxide, aluminum oxide, ferric oxide, and titanium dioxide. The principal minerals are derived from naturally occurring sources or mining byproducts.

### BRIEF DESCRIPTION OF THE DRAWINGS

The accompanying figures are incorporated in and constitute a part of this specification.

FIG. 1. is an energy dispersive X-ray spectroscopy of the potassium containing feldspar used in the product made according to Example 1.

FIG. 2. is a X-ray diffraction pattern of the potassium containing feldspar used in the product made according to Example 1.

### DESCRIPTION

“Cementitious material” means the natural elements that help hold concrete together, such as fly ash, slag and microsilica

“Geopolymer” means a polymeric Si—O—Al framework which is amorphous at room temperature. Geopolymers consist of SiO₄ and AlO₄ tetrahedral frameworks linked by shared oxygens.

“Mining byproducts” mean wastes that are generated during the extraction and beneficiation of ores and minerals. These wastes may include waste rock and mill tailings.

“Trace element” or “Trace amount” means a chemical element whose average concentration is less than 1% by weight, such as less than 0.1% by weight, or even less than 100 parts per million (ppm).

“Principal mineral(s)” mean the main or primary constituents of the decomposed ore from which the mineral is sourced. For example, clays described herein typically comprise principal minerals from the decomposition of orthoclase feldspar. Such principal minerals can contain oxides including silicon dioxide, aluminum oxide, ferric oxide, and titanium dioxide, for example.

“Calcination” is defined as heating to high temperatures in air or oxygen. More generally, calcination is used to mean a thermal treatment process in the absence or limited supply of air or oxygen applied to ores and other solid materials to bring about a thermal decomposition of the ore into separate compounds. Calcination reactions usually take place at or above the thermal decomposition temperature (for decomposition and volatilization reactions) or the transition temperature (for phase transitions).

Calcination is widely used in the cement industry, where limestone is converted by thermal decomposition into lime (CaO) and carbon dioxide (CO₂). This thermo-chemical process of calcination that is typically used in cement manufacturing requires the effects of temperature, decomposition pressure, diffusion, and pore efficiency to be taken into account during processing.

In contrast to the foregoing, a method of making cement using the disclosed geopolymer would be cheaper, easier, and more environmentally friendly as it does not require calcining to make a cement. For example, there is no costs or energy input needed to mine, manufacture, and transport the disclosed cement. This, along with the fact that there is no calcining step required, should reduce global carbon dioxide emissions. The cement described herein is not made from limestone, nor does it comprise the use of lime (CaO). Accordingly, in one embodiment, the resulting cementitious material is essentially free of Ca. As used herein, “essentially free of Ca,” means that Ca is found in trace amounts, at most.

As indicated and further described herein, geopolymers exhibit beneficial long-range, covalently bonded, and non-crystalline (amorphous) networks. Geopolymers are crystalline at temperatures exceeding 500° C. and are based on aluminum and silicon. The Si—O—Al framework is similar to that of zeolites, with the main difference between zeolites and geopolymers being that geopolymers are amorphous at room temperature instead of crystalline. Aluminum sources in nature do not exist as carbonates, and therefore do not release large quantities of carbon dioxide.

There are two typical synthesis routes for creating a geopolymers. The first is alkaline activation by sodium, potassium, and calcium. This method will yield poly(silicates)-poly(siloxo) type or poly(silico-aluminates)-poly(silate) type geopolymers. The second is acidic activation by phosphoric acid. This method will yield poly(phosphor-siloxo) and poly(alumino-phospho) type geopolymers.

Currently, geopolymers can be split up into a variety of classes based on the main material being used to create the geopolymer. For example, the most readily available materials to make geopolymers are fly ash and slag (which each constitute a class). Fly ash is a coal combustion by-product that is made up of particulates that leave the coal-fired boilers in the flue gas. The components of fly ash can vary considerably depending on the source; however, all fly ash contains a substantial amount of silicon dioxide, aluminum oxide, and calcium oxide. Slag, on the other hand, is the by-product left over after a metal has been separated from its raw ore. Similar to fly ash, the content of slag can vary. Slag, however, is usually a mixture of metal oxides and silicon dioxide. Although both fly ash and slag are useful for creating geopolymers, both materials depend on energy intensive and environmentally hazardous processes. Existing alternatives include the use of glass dust in place of fly ash or slag, but geopolymers produced using glass dust do not have the desired characteristics. Thus, there is a need to improve on existing geopolymers.

Concrete incorporating geopolymers has a number of advantages over traditional concretes made using, for example, Portland cement. For example, the process for manufacturing the geopolymers has an estimated 90% reduction in carbon dioxide emissions when compared to Portland cement. Furthermore, concretes made using geopolymers have better thermal insulation properties, higher temperature and fire resistance, and provide a viable use for waste materials which are typically disposed of in landfills. Nonetheless, even more efficient and environmentally friendly geopolymers are desired.

In a first embodiment, there is described a geopolymer made from principal minerals. The geopolymer comprises silicon dioxide (SiO₂), aluminum oxide (Al₂O₃), ferric oxide (Fe₂O₃), titanium dioxide (TiO₂), and balance water of hydration. In certain embodiments, the geopolymer also contains trace amounts of calcium.

In the geopolymer, the principal minerals are derived from naturally occurring sources. A naturally occurring source refers to any source that has not been significantly altered since being mined. For example, fly ash is produced through coal combustion and is collected out of the flue gas leaving the boilers. Accordingly, fly ash is not considered a naturally occurring source. Similarly, slag is a by-product that is produced during the smelting process for various ores. Slag, therefore, is also not considered a naturally occurring source. Examples of naturally occurring sources according to this disclosure are quartz, feldspar, staurolite, clay, or combinations thereof.

In some embodiments, the naturally occurring source is quartz. Quartz is a mineral composed of silicon and oxygen in a continuous framework of SiO₂. It is given the overall chemical formula of SiO₂. After feldspar, it is the most abundant mineral in the Earth's crust.

In some embodiments, the naturally occurring source is feldspar. Feldspars are rock-forming minerals distinguished by the presence of alumina and silica in their chemistry and include a large group of silicate minerals that make up over 50% of the Earth's crust. All feldspars fall within the following generalized principal mineral chemical composition: X(Al,Si)₄O₈. In this chemical composition X can be: potassium, sodium, calcium, barium, rubidium, strontium, or iron. The most common forms of feldspars contain either potassium, sodium, or calcium. Feldspars can be expressed in “endmembers,” which are principal minerals, with respect to the three major elements. These three endmembers are: potassium feldspar (KAlSi₃O₈), albite (NaAlSi₃O₈), and anorthite (CaAl₂Si₂O₈). In certain embodiments, the naturally occurring source is a potassium containing feldspar. In these embodiments, the principal mineral in the potassium containing feldspar is microcline, muscovite, or combinations thereof.

In some embodiments, the naturally occurring source contains staurolite. Staurolite is a neosilicate material with the chemical formula Fe²⁺₂Al₉O₆(SiO₄)₄(O,OH)₂. Magnesium, zinc, and manganese can all substitute for iron, and trivalent iron can substitute for aluminum. Staurolite crystalizes in the monoclinic crystal system.

In some embodiments, the naturally occurring source is a clay. Clays are typically made up of clay minerals (also principal minerals) with trace amounts of quartz, metal oxides, and organic matter. Clay minerals are generally composed of hydrous aluminum phyllosilicates, which can contain variable amounts of other elements such as iron, magnesium, alkali metals, alkaline earths, and other cations. In some embodiments, the naturally occurring clay comprises principal minerals from at least one of the kaolin group, smectite group, illite group, chlorite group, other 2:1 clay type such as sepiolite or attapulgite, or combinations thereof. In certain embodiments, the clay minerals are chosen from the kaolin group, and comprises at least one of kaolinite, dickite, halloysite, nacrite, or combinations thereof. In one embodiment, the clay mineral is kaolinite.

In some embodiments, the naturally occurring source comprises a combination of two or more of quartz, feldspar, staurolite, and clay. In certain embodiments, the naturally occurring source comprises quartz, feldspar, and clay. In other embodiments, the naturally occurring source comprises quartz, feldspar, staurolite, and clay. In some embodiments, the naturally occurring source may comprise trace amounts of elements such as titanium, magnesium, calcium, and manganese. In these embodiments, the elements most likely exist as silicate-based materials and metallic oxides.

In some embodiments, the naturally occurring source comprises a combination of various principal minerals. In certain embodiments, the principal minerals comprise quartz and kaolinite. In another embodiment, the principal minerals comprise quartz and microcline. In another embodiment still, the principal minerals comprise quartz and staurolite. In some embodiments, the principal minerals may further comprise silicate, hydroxide, or oxide minerals. In some embodiments, the principal minerals may further comprise leucite, goethite, hematite, magnetite, orthoclase, muscovite, or combinations thereof. In one example, the principal minerals further comprise leucite, goethite, and hematite. In another example, the principal minerals further comprise magnetite, orthoclase, muscovite, and goethite.

In an embodiment, quartz comprises at least 20% by weight of the principal minerals, such as from 20-90%. In an embodiment, microcline, staurolite, or kaolinite comprises at least 10% by weight of the principal minerals, such as from 10-80%. In other embodiments still, the additional principal minerals comprise less than 20% by weight of the principal minerals, such as from 0-20%.

In an embodiment, the geopolymer according to the disclosure is a cementitious material. In an embodiment, the geopolymer cementitious material has a compressive force equivalent to the industry standard when tested according to ASTM C39. In some embodiments, the geopolymer cementitious material has a compressive force of between 500-1000 psi unconstrained. This corresponded to a compressive forced of between 2000-4000 psi when using a constrained methodology. In another embodiment, the geopolymer cementitious material has a setting time of approximately 24 hours when tested in according to IS 4031 (Part 5)-1988.

In an embodiment, the geopolymer cementitious material comprises particles wherein at least 20% of the particles are smaller than 325 mesh size, i.e., smaller than 44 microns. In some embodiments, the geopolymer cementitious material comprises particles wherein at least 30%, at least 40%, at least 50%, at least 60%, at least 70%, at least 80%, at least 90%, at least 95%, or at least 98% of the particles are smaller than 325 mesh size, i.e., smaller than 44 microns.

There is also disclosed a geopolymer concrete comprising the reaction production of a geopolymer and an alkaline solution. The geopolymer is made from principal minerals. The geopolymer comprises silicon dioxide (SiO₂), aluminum oxide (Al₂O₃), ferric oxide (Fe₂O₃), titanium dioxide (TiO₂), and balance water of hydration. In certain embodiments, the geopolymer also contains trace amounts of calcium.

There is also disclosed a method of producing a geopolymer made from principal minerals. The geopolymer comprises silicon dioxide (SiO₂), aluminum oxide (Al₂O₃), ferric oxide (Fe₂O₃), titanium dioxide (TiO₂), and balance water of hydration. In certain embodiments, the geopolymer also contains trace amounts of calcium.

In an embodiment, the method comprises first drying the at least one natural source or byproducts from mining operations containing principal minerals to remove free water. It is not necessary to remove the water of hydration. The drying step is carried out by heating, and can be heated at low temperatures, such as below 900° F. In one embodiment, the drying step is conducted at approximately 450° F. Accordingly, the disclosed method does not form clinker through sintering of the principal minerals. The lower temperature allows for a significant reduction in energy usage, and therefore a reduction in air emissions and cost.

The method then comprises grinding the dried material to a particular size which is determined based on the end use. In some embodiments, over-sized particles are reprocessed to achieve final targeted sized distribution. The method next comprises mixing the dried material with sodium silicate. In some embodiments, sodium aluminate or potassium aluminate can be added to the material to accelerate the reaction. In some embodiments, the sodium silicate is a liquid. In certain embodiments, the sodium silicate liquid is 10 to 40 parts weight percentage dry sodium silicate. In other embodiments, the sodium silicate is a dry powder.

The method of producing the geopolymer according to this disclosure has significantly lower air emissions and energy requirements when compared to manufacturing Portland cement. Without being bound by theory, one of the major reductions in air emissions comes from the fact that calcium carbonates are not present in the principal minerals, and thus carbon dioxide gas is not present as a byproduct. In addition, the method according to this disclosure requires significantly less energy requirements than for producing Portland cement.

The method of producing the geopolymer according to this disclosure also has lower air emissions and energy requirements when compared to manufacturing geopolymers based on fly ash or slag. Unlike both fly ash and slag, the principal minerals using in the geopolymers according to this disclosure are taken from naturally occurring sources or byproducts of the mining processes. Therefore, there is no requirement to combust coal or smelt ore to get the principal minerals. Additionally, the temperatures required for heating the principal minerals is much lower than for geopolymers based on fly ash or slag, resulting in a much lower energy requirement.

There is also disclosed a method of producing a geopolymer concrete. In an embodiment, the method comprises first backfilling the geopolymer made from principal minerals and an alkaline solution. The geopolymer comprises silicon dioxide (SiO₂), aluminum oxide (Al₂O₃), ferric oxide (Fe₂O₃), titanium dioxide (TiO₂), and balance water of hydration. In certain embodiments, the geopolymer also contains trace amounts of calcium. Next, the method comprises allowing the mixture to set for approximately 24 hours.

Measurement Techniques:

Compressive Strength. The test for compressive strength is typically carried out on either a concrete cube or cylinder. American Society for Testing Materials ASTM C39/C39M provides Standard Test Method for Compressive Strength of Cylindrical Concrete Specimens.

Setting Time refers to the cycle of time in which cement is mixed with water for hydration to make a cement paste. The paste is able to be molded for a period of time due to its plasticity but starts to harden over time as it loses its plasticity. The time at which the cement hardens is the final setting time of the cement. The setting time is tested according to IS 4031 (Part 5)-1988.

Characterization of principal minerals. Energy dispersive X-ray spectroscopy (EDS) is performed on a sample per ASTM E1508-12a at 20 kV using a Thermo Scientific Ultra Dry Detector Model No. 2261A-3UUS-SN, S/N: 7756. A sample is deposited onto an aluminum sample holder, and analyzed via x-ray diffraction. A Rigaku Ultima III detector, S/N: D03659N x-ray diffractometer with a high precision theta-theta goniometer is used to qualitatively identify the crystalline phases. X-ray intensity counts versus diffraction angle data are collected and processed. The x-ray diffraction patterns are analyzed using automated search/match methods based on compound in the International Centre for Diffraction Data (ICDD) PDF-2 databases.

### EXAMPLES

The following non-limiting examples, which are intended to be exemplary, further clarify the present disclosure.

### Example 1. Characterization of the Principal Minerals in Quartz/Feldspar Combination

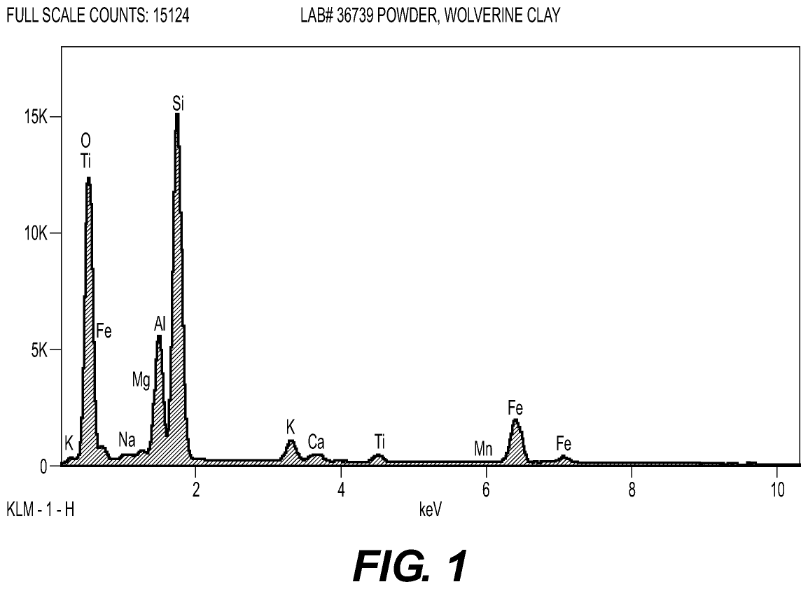

Energy dispersive X-ray spectroscopy (EDS) was carried out on a sample of a mixture of naturally occurring sources. The qualitative spectrum is shown in FIG. 1. The semi-quantitative results are shown below in Table 1:

| | | Weight % |
|---|---|---|
| Element | Weight % | Error (+/−) |
| O | 52.18 | 0.24 |
| Na | 0.66 | 0.04 |
| Mg | 0.36 | 0.03 |
| Al | 8.09 | 0.10 |
| Si | 24.17 | 0.11 |
| K | 1.76 | 0.05 |
| Ca | 0.49 | 0.02 |
| Ti | 0.84 | 0.05 |
| Mn | 0.22 | 0.04 |
| Fe | 11.23 | 0.09 |
| Total | 100 | |

The sample was composed primarily of oxygen, aluminum, silicon, iron, and potassium. Lesser amounts of titanium, sodium, magnesium, calcium, and manganese were also detected. These elements most likely existed as silicate-based minerals and metallic oxides.

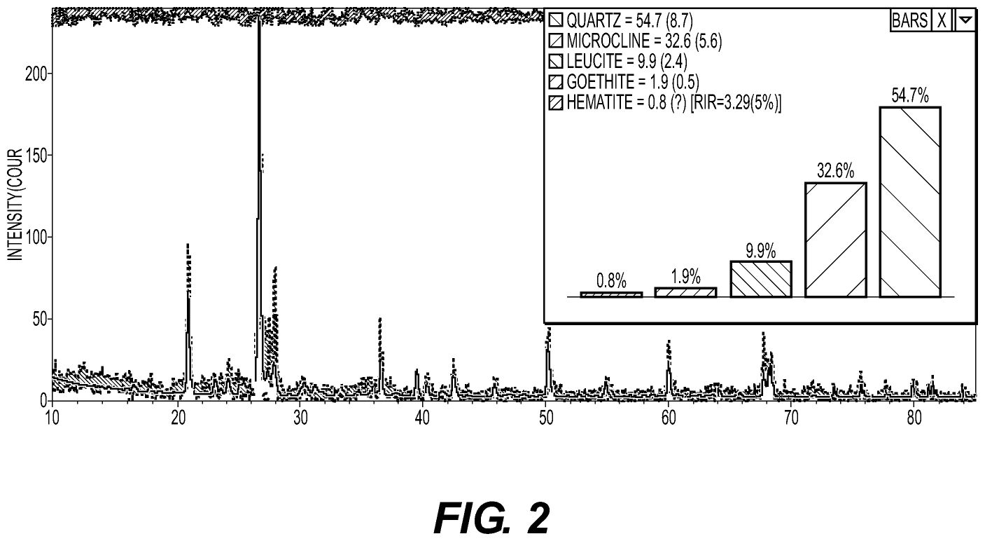

X-ray diffraction analysis was also carried out on the sample. The X-ray diffraction pattern is shown in FIG. 2. The X-ray diffraction pattern data yielded several sharp peaks between 20 and 70 degrees two-theta. These signals were attributed to oxide and silicate forms of mainly silicon, iron, aluminum, and potassium. The tabulated data is shown in Table 2:

| Mineral Name | Chemical Formula | Weight % |
|---|---|---|
| Quartz | SiO₂ | 54.7 |
| Microcline | KAlSi₃O₈ | 32.6 |
| Leucite | KAlSi₂O₆ | 9.9 |
| Goethite | FeO(OH) | 1.9 |
| Hematite | Fe₂O₃ | 0.8 |

### Example 2. Characterization of the Principal Minerals in Quartz/Staurolite Combination

Testing as described in example 1 was carried out on two additional samples comprising principal minerals. The tabulated data for the X-ray diffraction is shown in Table 3:

| | | Sample 1 | Sample 2 |
|---|---|---|---|
| Mineral Name | Chemical Formula | Weight % | Weight % |
| Quartz | SiO₂ | 81.7 | 85.1 |
| Staurolite | Fe₂Al₉Si₄O₂₂(OH)₂ | 15.1 | 13.4 |
| Magnetite | Fe₃O₄ | 2.2 | 0.2 |
| Orthoclase | KAlSi₃O₈ | 0.5 | 0 |
| Muscovite | KAl₂(AlSi₃O₁₀)(OH)₂ | 0.4 | 0.8 |
| Goethite | FeO(OH) | 0.3 | 0.1 |
| Microcline | KAlSi₃O₈ | 0 | 0.4 |

### Example 3. Compressive Strength of Cementitious Geopolymers

A cementitious geopolymer was prepared according to the disclosure. The cementitious geopolymer was then tested for compressive strength according to ASTM C39.

### Example 4. Setting Time of Cementitious Geopolymers

A cementitious geopolymer was prepared according to the disclosure. The cementitious geopolymer was then tested for setting time according to IS 4031 (Part 5)-1988.

Other embodiments of the invention will be apparent to those skilled in the art from consideration of the specification and practice of the invention disclosed herein. It is intended that the specification and examples be considered as exemplary only, with the true scope of the invention being indicated by the following claims.

What is claimed is:

1. A cementitious material comprising a geopolymer composition comprising principal minerals derived from at least one naturally occurring source or mining byproduct, wherein the geopolymer comprises a long-range, covalently bonded network of at least one oxide of silicon, aluminum, iron, or titanium.

2. The cementitious material of claim 1, wherein the geopolymer composition comprises silicon dioxide, aluminum dioxide, ferric oxide, and titanium oxide.

3. The cementitious material of claim 1, wherein the geopolymer composition further comprises trace amounts of calcium.

4. The cementitious material of claim 1, wherein the at least one naturally occurring source or mining byproduct is chosen from quartz, feldspar, staurolite, clay, or combinations thereof.

5. The cementitious material of claim 4, wherein the feldspar comprises potassium.

6. The cementitious material of claim 1, wherein the principal minerals comprise at least one of quartz, microcline, staurolite, muscovite, leucite, goethite, hematite, magnetite, orthoclase, or combinations thereof.

7. The cementitious material of claim 6, wherein the principal minerals comprise quartz, microcline, leucite, goethite, and hematite.

8. The cementitious material of claim 6, wherein the principal minerals comprise quartz, staurolite, magnetite, orthoclase, muscovite, and goethite.

9. The cementitious material of claim 6, wherein the principal minerals comprise quartz, staurolite, magnetite, muscovite, goethite, and microcline.

10. The cementitious material of claim 4, wherein the at least one naturally occurring source further contains at least one of sodium, manganese, calcium, magnesium, or combinations thereof.

11. The cementitious material of claim 1, wherein the cementitious material has a compressive strength of between about 500-1000 psi unconstrained.

12. The cementitious material of claim 1, wherein the geopolymer is substantially free of fly-ash or slag.

13. A method of making a geopolymer composition, the method comprising:
drying at least one principal mineral that is derived from a naturally occurring source or mining byproducts to form a dried material;
grinding the dried material to form a dried powder; and
mixing the dried powder with sodium silicate for a time sufficient to form a geopolymer;
wherein the geopolymer comprises at least one oxide of silicon, aluminum, iron, or titanium.

14. The method of claim 13, which does not include a calcining step.

15. The method of claim 13, wherein the at least one naturally occurring source or mining byproduct is chosen from quartz, feldspar, staurolite, clay, or combinations thereof.

16. The method of claim 15, wherein the feldspar is a potassium containing feldspar.

17. The method of claim 16, wherein the principal minerals are at least one of quartz, microcline, staurolite, muscovite, leucite, goethite, hematite, magnetite, orthoclase, or combinations thereof.

18. The method of claim 15, wherein the at least one naturally occurring source further contains at least one of sodium, manganese, calcium, magnesium, or combinations thereof.

19. The method of claim 13, wherein the drying step is conducted at temperatures less than approximately 900° F.

20. The method of claim 19, wherein the drying step is conducted at a temperature of approximately 450° F.

21. The method of claim 13, wherein the second sodium silicate is in liquid form.

22. The method of claim 21, wherein the liquid is 10-40 parts dry sodium silicate by weight.

23. The method of claim 13, wherein the sodium silicate is in powder form.

24. A concrete material comprising a geopolymer cementitious material and an alkaline solution, wherein the geopolymer cementitious material is substantially free of fly-ash or slag and comprises at least one oxide of silicon, aluminum, iron, or titanium, and further wherein the principal minerals are derived from at least one naturally occurring source or mining byproduct.

25. The concrete material of claim 24, wherein the geopolymer cementitious material comprises silicon dioxide, aluminum dioxide, ferric oxide, and titanium oxide.

26. The concrete material of claim 24, wherein the geopolymer cementitious material further comprises trace amounts of calcium.

27. The concrete material of claim 24, wherein the at least one naturally occurring or source mining byproduct is chosen from quartz, feldspar, staurolite, clay, or combinations thereof.

28. The concrete material of claim 27, wherein the feldspar comprises potassium.

29. The concrete material of claim 24, wherein the principal minerals are at least one of quartz, microcline, staurolite, muscovite, leucite, goethite, hematite, magnetite, orthoclase, or combinations thereof.

30. The concrete material of claim 24, wherein the geopolymer cementitious material has a compressive strength of between about 500-1000 psi unconstrained.

31. The concrete material of claim 24, wherein the concrete material has a setting time of 24 hours.

32. The concrete material of claim 24, wherein the geopolymer cementitious material is substantially free of fly-ash or slag.
